(19) United States
(12) Patent Application Publication
(10) Pub. No.: US 2026/0361614 A1
(43) Pub. Date: Nov. 12, 2026

(54) SYSTEMS AND METHODS FOR IMPLEMENTING SOFTWARE-DEFINED ARTIFICIAL INTELLIGENCE (AI) MODELS IN WIRELESS MOBILITY NETWORKS

(71) Applicant: AT&T Intellectual Property I, L.P., Atlanta, GA (US)

(72) Inventors: Hongyan Lei, Plano, TX (US); Yupeng Jia, South Pasadena, CA (US)

(73) Assignee: AT&T Intellectual Property I, L.P., Atlanta, GA (US)

(21) Appl. No.: 19/199,828

(22) Filed: May 6, 2025

(51) Int. Cl. H04L 41/16; H04B 7/06; H04L 41/342

(52) U.S. Cl. CPC H04L 41/16; H04B 7/0617; H04L 41/342

(57) ABSTRACT

Aspects of the subject disclosure may include, for example, selecting a target virtualized network function among a plurality of virtualized network functions in a wireless mobility network, deploying one or more software-defined artificial intelligence (AI) models configured to perform the target virtualized network function, and running the software-defined AI models on commercial off-the-shelf hardware. Other embodiments are disclosed.

### FIELD OF THE DISCLOSURE

The subject disclosure relates to systems and methods for implementing software-defined artificial intelligence (AI) models in wireless mobility networks.

### BACKGROUND

AI technologies have changed and will change wireless mobility networks in profound ways. Currently AI adoption is constrained by its reliance on expensive, purpose-built hardware such as GPUs and specialized processors, which drive up costs and limit accessibility for smaller organizations. For instance, in Radio Access Networks (RAN), critical network functions often depend on custom hardware, increasing operational expenses and reducing scalability.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of another system in accordance with various aspects described herein.

FIG. 2C is a block diagram illustrating a prior art system.

FIG. 2D is a block diagram illustrating an example, non-limiting use case in accordance with various aspects described herein.

FIG. 2E depicts an illustrative embodiment of a method in accordance with various aspects described herein.

FIG. 2F depicts an illustrative embodiment of another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for systems and methods for implementing a software-defined artificial intelligence (AI) model in wireless mobility networks by removing AI dependency on an expensive purpose-built hardware and making the AI flexible and cost effective via software implementation. The systems and methods implement the software-defined AI model on a commercial off-the-shelf (COTS) hardware rather than a purpose-built hardware. The systems and methods further utilize the software-defined AI models on network functions in the wireless mobility networks, such as massive MIMO, beamforming, interference mitigation, etc., which require intensive computing and low latency (i.e., substantially real-time actions). Other embodiments are described in the subject disclosure.

One or more aspects of the subject disclosure are directed to a system including a processing system including a processor of a network node in a wireless mobility network, and a memory that stores executable instructions that, when executed by the processing system, facilitate performance of operations. The operations include selecting a target virtualized network function among a plurality of virtualized network functions based on a plurality of factors, deploying one or more software-defined artificial intelligence (AI) models configured to perform the target virtualized network function, and running the one or more software-defined AI models on a commercial off-the-shelf (COTS) hardware.

One or more aspects of the subject disclosure are directed to a non-transitory machine-readable medium, comprising executable instructions that, when executed by a processing system including a processor, facilitate performance of operations. The operations comprise selecting a virtualized network function among a plurality of virtualized network functions in multiple network nodes distributed in a wireless mobility network, wherein the plurality of virtualized network functions are not running on a purpose-built hardware, and wherein the selecting is based on a plurality of requirements including a low latency, high performance computing, a resource tradeoff, or a combination thereof; implementing the selected virtualized network function with a software-defined artificial intelligence (AI) model; and running the software-defined AI model on a commercial off-the-shelf (COTS) hardware.

One or more aspects of the subject disclosure are directed to a method including deploying, by a processing system including a processor, a plurality of software-defined artificial intelligence (AI) models across distributed network nodes in a wireless mobility network, wherein the plurality of software-defined AI models are configured to perform one or more virtualized network functions in the wireless mobility network, and utilizing, by the processing system, commercial off-the-shelf (COTS) hardware to run the plurality of software-defined AI models.

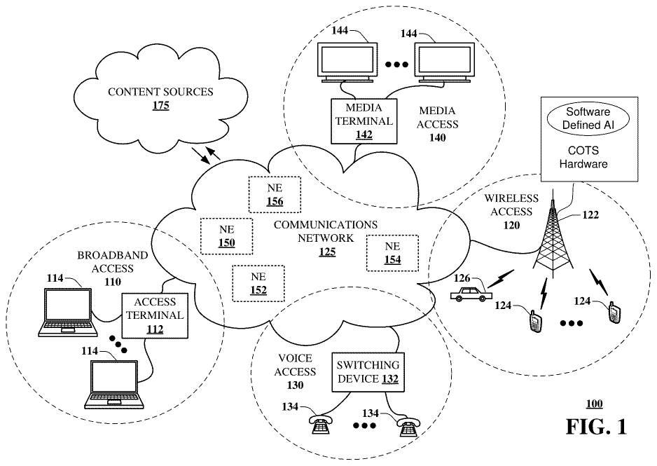

Referring now to FIG. 1, a block diagram is shown illustrating an example, non-limiting embodiment of a system 100 in accordance with various aspects described herein. For example, system 100 can facilitate in whole or in part systems and methods for implementing software-defined artificial intelligence (AI) in wireless mobility networks. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

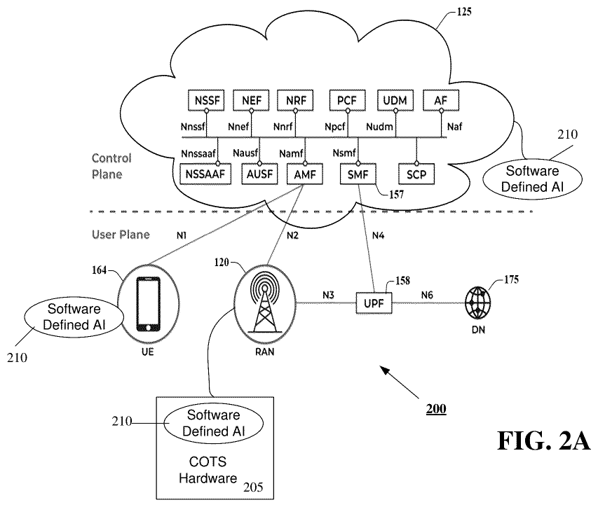

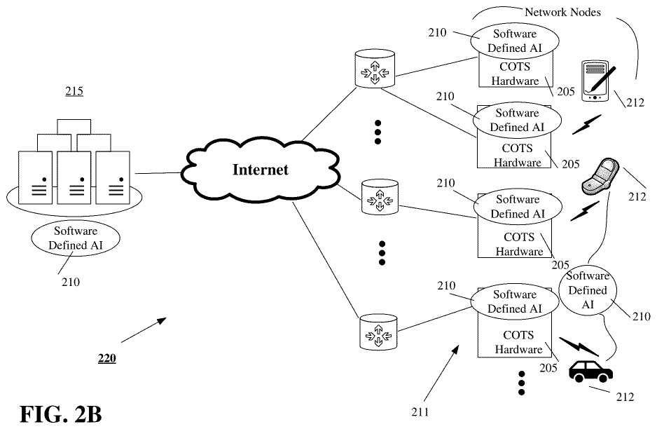

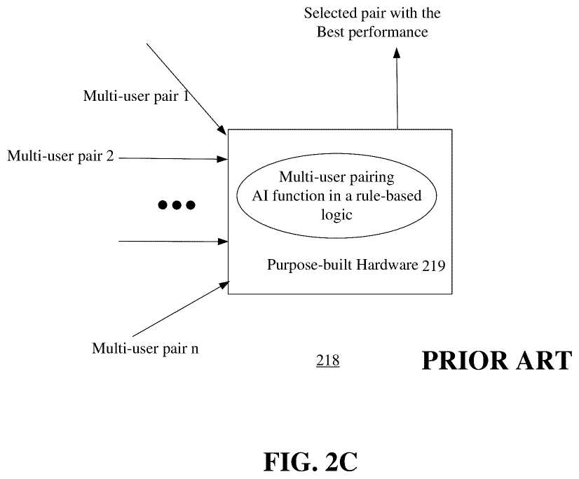

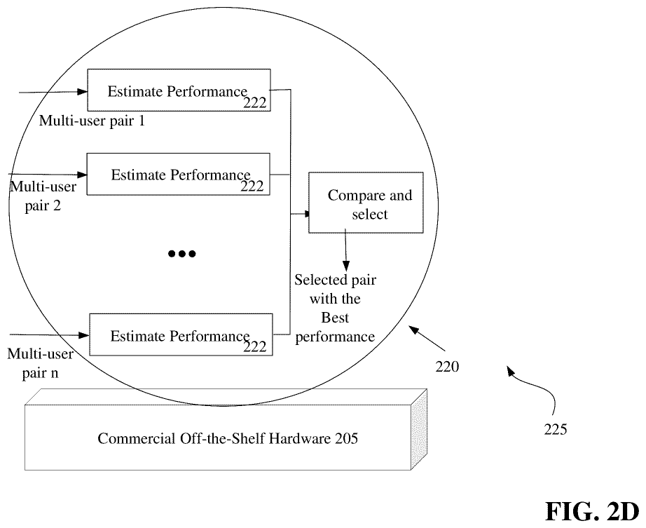

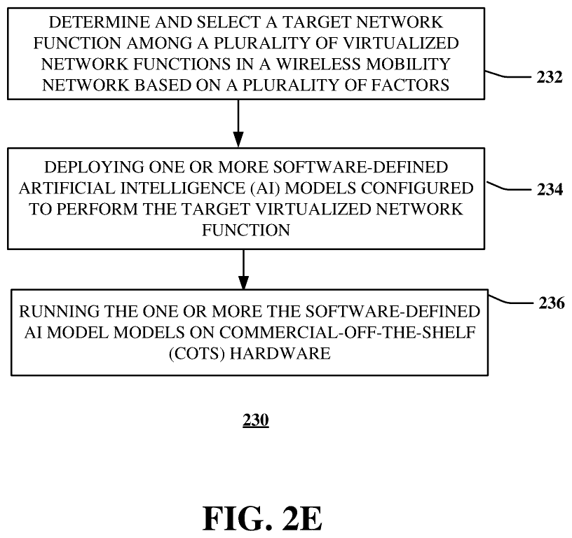

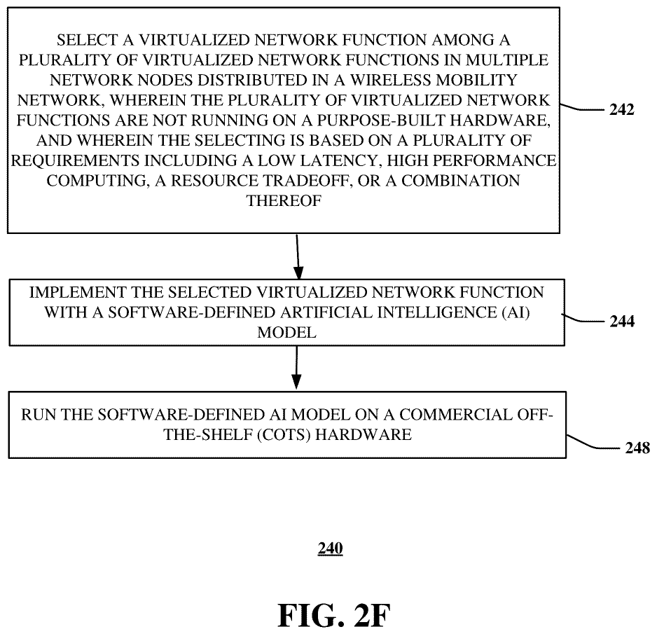

FIG. 2A is a block diagram illustrating an example, non-limiting embodiment of a system 200 functioning within the communication network of FIG. 1 in accordance with various aspects described herein. FIG. 2A illustrates a system architecture for integrating software-defined AI models across various network nodes within a wireless mobility network such as 5G networks. The system 200 illustrates deployment and distribution of the software-defined AI models 210 at multiple network nodes, including the user equipment 164, the RAN 120, and the mobile core network, etc., to enable AI-driven functionalities. As depicted in FIG. 2A, the software-defined AI models 210 are implemented on commercial off-the-shelf (COTS) hardware 205, rather than a purpose-built hardware.

COTS, or Commercial Off-The-Shelf hardware 205, refers to readily available hardware products that are designed for the general market, contrary to a purpose-built hardware, and can be purchased and used without any custom modifications. Additionally or alternatively, COTS hardware 205 is usually from a general hardware vendor, and RAN specific software is from RAN vendor designed per a network operator's requirements. A buyer can choose to buy hardware and software separately from different sellers, or a third party integrator may integrate hardware and software and then sell them to the operator or the buyer. The COTS hardware 205 is typically mass-produced and sold through commercial channels, making them more cost-effective compared to custom-built hardware solutions. Advantages of COTS Hardware 205 include cost-effectiveness, wide availability, easy standardization, reliability, and can be adapted to support a variety of applications. The COTS hardware 205 is used in numerous sectors, including telecommunications, defense, healthcare, and information technology. In telecommunications, for example, COTS hardware can be employed in network infrastructure to support functions such as routing, switching, and data processing. With the software-defined AI model 210, the COTS hardware 205 enables the deployment of AI solutions on affordable and widely available platforms, reducing the dependency on expensive, specialized hardware, the purpose-built hardware (e.g., GPUs).

In the user plane, the system 200 includes the user equipment 164 connected to the RAN 120 that communicates with the user plane function 158 and the data network 175 via interfaces labeled N1, N2, N3, N4, and N6. The software-defined AI models 210 are integrated into the user equipment 164, RAN 120, and the mobile core network 125, leveraging COTS hardware 205 to facilitate operations such as RAN scheduling, interference mitigation, and massive MIMO optimization and beamforming. By utilizing COTS hardware 205, the system 200 may reduce costs and enhance flexibility without relying on specialized, purpose-built hardware.

In the control plane, the system 200 incorporates network functions such as NSSAAF, AUSF, AMF, SMF, and SCP, etc., which interact with the user plane components 158 to manage network operations. The software-defined AI model 210 is deployed within the control plane as depicted in FIG. 2A. The system 200 depicts the software-defined AI models 210 distributed in wireless mobility networks, leveraging software-based solutions on COTS hardware 205 to achieve cost-effective and scalable AI integration.

Implementing the software-defined AI model on commercial off-the-shelf (COTS) hardware can be facilitated by virtualization of wireless mobility network functions, such as Radio Access Network (RAN) virtualization, involving decoupling of hardware and software components. RAN virtualization converts certain network functions into virtualized software applications to operate on general-purpose hardware, eliminating the need for expensive, purpose-built hardware. RAN virtualization is a key component of the broader trend towards network function virtualization (NFV) and software-defined networking (SDN). More specifically, traditional RANs are built on specialized hardware that integrates both the radio and baseband processing functions. Virtualization separates these functions, allowing them to run on commercial off-the-shelf (COTS) hardware, which is more flexible and cost-effective. RAN virtualization supports both centralized and distributed network architectures. In a centralized RAN (C-RAN), baseband processing is centralized in a data center, while remote radio heads (RRHs) are deployed at cell sites. This centralization can lead to more efficient resource utilization and easier network management. RAN virtualization is part of the NFV framework, which aims to virtualize network services traditionally run on proprietary hardware. This allows for dynamic allocation of resources and the ability to scale network functions as needed. SDN complements RAN virtualization by providing a programmable network architecture. It allows for centralized control and management of the network, enabling more agile and responsive network operations. By removing the dependency on proprietary hardware, RAN virtualization may lower capital and operational expenditures, extend the lifecycle of network infrastructure, and facilitate the deployment of new features and services.

In the context of Radio Access Network (RAN) virtualization, L1, L2, and L3 refer to the three layers of the RAN protocol stack, each responsible for specific functions in wireless communication. The L1 layer, or physical layer, is responsible for the actual transmission and reception of data over the air interface between the base station and user equipment (UE). It handles functions such as modulation and demodulation, channel coding and decoding, beamforming, signal processing, and resource mapping. Virtualizing L1 functions is challenging due to their real-time nature and high computational demands, especially for tasks like Massive MIMO and beamforming, which require low latency and intensive processing traditionally relying on purpose-built hardware.

The L2 layer, or data link layer, manages the reliable transmission of data between the base station and UE and is divided into three sublayers: Medium Access Control (MAC), which handles scheduling, resource allocation, and retransmissions; Radio Link Control (RLC), which provides segmentation, reassembly, and error correction for data packets; and Packet Data Convergence Protocol (PDCP), which performs header compression, encryption, and integrity protection for user data. L2 functions are less computationally intensive than L1 functions but still require low latency for real-time operations, and virtualizing them enables flexibility in resource management and supports dynamic network configurations.

The L3 layer, or network layer, is responsible for higher-level control and signaling functions, primarily managing connections and mobility. Key functions include Radio Resource Control (RRC), which handles signaling for connection setup, maintenance, and release, as well as mobility, handovers, and quality of service (QoS); and Non-Access Stratum (NAS), which facilitates communication between the UE and the core network for authentication, session management, and mobility management. L3 functions are typically non-real-time and less computationally demanding compared to L1 and L2, making their virtualization relatively straightforward and widely adopted in commercial deployments, often implemented in centralized locations such as virtualized central units (vCUs).

Virtualization of L3 functions began earlier due to their non-real-time nature, followed by L2 functions deployed at cell sites in virtualized distributed units (vDUs). Virtualizing L1 functions, the most challenging due to their real-time requirements and computational intensity, has recently been enabled for frequency division duplex (FDD) bands and time division duplex (TDD) bands, including Massive MIMO functionalities.

In various embodiments, at least some of RAN virtualized functions can be determined and selected to be implemented with the software-defined AI model based on multiple factors. For instance, some of RAN virtualized functions may require complex, high performance computing and simultaneously have a low latency requirement. Moreover, it is considered as one of the multiple factors whether implementing such functions with the software-defined AI model and running on the COT hardware 205 may be more cost effective than AI embedded specialized hardware. The software-defined AI model leverages software to replace embedded AI functionalities traditionally implemented in specialized hardware to perform the at least some of the virtualized functions, enabling AI models to run on COTS hardware without requiring custom-built solutions. When this approach may potentially lower the cost of AI deployment, AI technologies can be more accessible to smaller organizations and industries.

FIG. 2B is a block diagram illustrating an example, non-limiting embodiment of another system 220 in accordance with various aspects described herein. FIG. 2B illustrates an architecture of the system 220 for deploying the software-defined AI models 210 within the wireless mobility network. In particular, FIG. 2B shows a data center 215 connected to various network nodes 212 over the Internet, forming a distributed system that integrates the software-defined AI models 210 across multiple components or network nodes. Both the data center 215 and at least some of the network nodes are implemented to include the software-defined AI models 210 running on the commercial off-the-shelf (COTS) hardware 205, reducing or minimizing the need for purpose-built hardware while maintaining scalability and cost efficiency.

The data center 215 serves as a centralized hub for managing AI-driven functionalities, such as RAN scheduling, interference mitigation, and massive MIMO optimization. The data center 215 communicates with different network nodes 211, 212 over the Internet, enabling seamless integration of AI capabilities across the wireless mobility network. Each network node, equipped with the COTS hardware 205, hosts the software-defined AI model 210 to perform localized AI tasks, ensuring efficient resource allocation and low-latency operations. In some embodiments, the software-defined AI models 210 may communicate with one another and coordinate completion of tasks by dividing the tasks and contributing to the completion of the tasks. For instance, the software-defined AI model 210 residing in the data center 215 may operate as a centralized AI model that performs the coordination of the distributed software defined AI models 210 in the different network nodes such as 211, 212.

The software-defined AI models 210 are distributed and implemented on various forms of user equipment 212, such as smartphones, tablets, and connected vehicles. This distributed deployment allows AI functionalities to operate closer to the source of data, reducing latency and enhancing real-time decision-making. By leveraging COTS hardware 205 across the data center 215, network nodes 211, including user equipment 212, the system 220 supports scalable and cost-effective AI integration throughout the wireless mobility network. The distributed AI utilizes deploying AI functionalities across multiple nodes 211 or devices 212, allowing them to work collaboratively. Computational resources may be allocated at various devices, such as servers, edge devices, or even user equipment to perform AI tasks, as depicted in FIG. 2B. All distributed AI models can contribute to the same task thus to achieve the similar results. The distributed AI models may provide various advantages such as scalability by adding more nodes to the network as needed, flexibility by dynamically allocating tasks across the network nodes 210, 211 based on current resource availability, robustness as the loss of a single node does not necessarily disrupt the entire system, etc. The distributed AI models may further provide cost effectiveness by using existing infrastructure and COTS hardware, instead of specialized, high-end hardware.

In various embodiments, the software-defined AI models 210 facilitate better AI modeling and algorithm. The software-defined AI models 210 may determine to be applied to a certain type of transactions or functions that carry importance, such as AI communication with the application such as RAN scheduling. For instance, AI and the RAN scheduler have regular communications on resource prioritization. If AI predicts an incoming critical application such as Mission Critical services, AI will inform a RAN scheduler. The RAN scheduler will take it into account and prioritize RAN resources for this coming mission critical service. Another example, AI may contact AI agents in other RAN cells and predict the traffic changes in the area. The AI agents can communicate with the RAN scheduler and prepare resources for the traffic change. Another example is a security case like signal storm attach prediction. AI can inform the RAN scheduler to prioritize the resources accordingly. The software-defined AI model may make a determination based on a resource tradeoff. The software-defined AI model utilizes software to implement at least some of virtualized network functions and lower the cost.

FIG. 2C is a block diagram illustrating a prior art system 218. FIG. 2C illustrates the prior art system 218 that relies on a purpose-built hardware to implement a particular network function, such as multi-user pairing in massive MIMO systems.

Massive Multiple-Input Multiple-Output (MIMO) systems use multiple antennas at both the transmitter and receiver to improve communication performance by exploiting spatial diversity and spatial multiplexing. Massive MIMO employs a very large number of antennas, often in the range of hundreds, at the base station to serve multiple users simultaneously in the same frequency band. Massive MIMO systems may significantly increase spectral efficiency by enabling multiple users to share the same time-frequency resources, achieved through advanced beamforming techniques that direct signals to specific users while minimizing interference. Massive MIMO systems improve energy efficiency by focusing energy in the direction of intended users, reduce power consumption, and enhance reliability by mitigating interference through precise spatial filtering. Additionally, massive MIMO systems are designed to support a large number of users simultaneously, making them ideal for high-density environments such as urban areas and stadiums.

The performance of massive MIMO systems is influenced by multiple factors, including channel state information (CSI) accuracy, interference management, antenna configuration, and computational efficiency. Accurate CSI is critical for optimizing beamforming and spatial multiplexing, as the CSI provides detailed information about the wireless channel's characteristics. However, obtaining and processing CSI can be computationally intense, especially in dynamic environments with rapidly changing channel conditions. Interference management is another key factor, as massive MIMO systems must mitigate interference between users and between cells to ensure reliable communication. This may require advanced algorithms to optimize resource allocation and signal processing. The configuration and placement of antennas also play a significant role in performance, as the number, spacing, and orientation of antennas directly impact the system's ability to achieve high spectral efficiency and spatial resolution. Additionally, the computational efficiency of the system should be considered, as massive MIMO operations involve complex matrix calculations and real-time processing, which can strain hardware resources.

Currently, many massive MIMO systems rely on rule-based logic to perform the functions such as beamforming and interference mitigation. Rule-based logic uses predefined rules and algorithms to make decisions based on input data. The rule-based logic may be often slow to converge, particularly in complex scenarios with multiple variables and dynamic conditions. Rule-based logic also has limitations in decision-making, as it may not be adapted to unforeseen situations or optimize performance in real-time.

As depicted in FIG. 2C, massive MIMO system is implemented, using specialized, purpose-built hardware 219 to handle the intensive computational requirements of tasks such as beamforming, channel estimation, and interference mitigation. These tasks involve complex matrix operations and real-time processing, which are typically executed on high-performance hardware such as Field-Programmable Gate Arrays (FPGAs), Application-Specific Integrated Circuits (ASICs), or Graphics Processing Units (GPUs). Beamforming is one of functions in MIMO systems, where the base station uses its multiple antennas to direct signals toward specific users, requiring precise control of the phase and amplitude of the transmitted signals, which is computationally intensive and often implemented in a customer hardware. Specialized hardware is expensive to develop, deploy, and maintain, making it less accessible for smaller operators or organizations. It is designed for specific tasks, making it difficult to adapt to new requirements or technologies without significant upgrades. Scaling up massive MIMO systems with specialized hardware can be cost-prohibitive and operationally complex, and hardware-based solutions often have shorter lifecycles due to rapid advancements in technology, requiring frequent replacements or upgrades.

In the prior art system 218, multi-user pairing are centralized and executed on a specialized hardware designed specifically for intensive computational tasks. The prior art system 218 evaluates multiple user pair combinations (multi-user pair 1, multi-user pair 2, multi-user pair n) and selects the pair with the best performance based on predefined criteria.

FIG. 2D is a block diagram illustrating an example, non-limiting use case in accordance with various aspects described herein. FIG. 2D illustrates a system 225 for implementing the software-defined AI models 220 on commercial off-the-shelf (COTS) hardware 205 to perform AI-driven network functionalities, such as multi-user pairing in massive MIMO systems. In this system 225, multiple user pair combinations, including multi-user pair 1, multi-user pair 2, and multi-user pair n, are evaluated with respect to their performance, using the software-defined AI models 220 running on COTS hardware 205. The software-defined AI models 220 facilitate the performance estimation 222 for each user pair and selects the pair with the best performance based on predefined criteria. By leveraging COTS hardware, the software-defined AI model algorithms 220 may eliminate the need for expensive, purpose-built hardware while maintaining high performance and scalability.

In some embodiments, the software-defined AI models 220 are configured to carry out, using the software-defined AI models 220 in one network node, the performance estimate 222 with respect to a plurality of multi-user pairs such as Multi-user pair 1, Multi-user pair 2, Multi-user pair N, etc. In other embodiments, the software-defined AI models 220 are configured to carry out, using the software-defined AI models in multiple different network nodes, the performance estimate 222 with respect to a plurality of multi-user pairs such as Multi-user pair 1, Multi-user pair 2, Multi-user pair N, etc., respectively. In other words, multiple software-defined AI models residing in different network nodes can be coordinated and contribute to carrying out the performance estimate with respect to different user pairs. The software-defined AI models 220 in multiple different network nodes communicate with one another for necessary coordination of contribution and completion of tasks. The distributed nature of the software-defined AI model in FIG. 2D thus may enhance flexibility and robustness. By breaking down complex AI tasks into smaller, software-implemented functions, the system 225 can dynamically allocate resources and adapt to changing demands.

As another example, the system 225 is configured to implement beamforming in wireless communication systems. Beamforming involves the precise control of the phase and amplitude of signals transmitted or received by multiple antennas to focus the signal energy in specific directions. Beamforming is used to target individual users or devices while minimizing interference to others, thereby optimizing the use of available resources. The implementation of beamforming requires intensive computing such as high performance computing (HPC) due to the complexity of the mathematical operations involved. Beamforming relies on advanced algorithms to calculate the optimal weights for each antenna element, which are used to adjust the phase and amplitude of the transmitted or received signals. These calculations often involve large-scale matrix operations, such as matrix inversions and eigenvalue decompositions, which are computationally demanding. Additionally, beamforming algorithms must account for dynamic factors such as channel state information (CSI), user mobility, and interference patterns, further increasing the computational load.

Low latency is another requirement for beamforming, especially in real-time applications such as Massive MIMO systems. Beamforming decisions must be made quickly to adapt to rapidly changing channel conditions and user locations. For example, in environments with high user density or fast-moving devices, the wireless channel characteristics can change within milliseconds. To maintain optimal performance, the system must process CSI, compute beamforming weights, and apply them to the antennas in near real-time. Any delay in this process can result in degraded signal quality, increased interference, and reduced network efficiency.

Traditionally, beamforming has been implemented using specialized, purpose-built hardware. These hardware solutions are designed to handle the intensive computational requirements and low-latency demands of beamforming. The system 225 may select and implement beamforming with the software-defined AI models 220 running on the COTS hardware 205 in light of these factors such as intensive computational requirements, the low-latency demands, the expensive specialized, purpose-built hardware requirements, high cost, etc. Computing needed for beamforming may be divided into multiple functions which will be handled and implemented with multiple the software-defined AI models 220.

FIG. 2E depicts an illustrative embodiment of a method 230 in accordance with various aspects described herein. In various embodiments, the method 230 implements software-defined AI models in wireless mobility networks. The method 230 leverages commercial off-the-shelf (COTS) hardware to enable cost-effective and scalable AI functionalities across various network components.

The method 230 includes, in a network node of a plurality of network nodes, determining and selecting a target virtualized network function among a plurality of virtualized network functions based on a plurality of factors (Step 232), deploying one or more software-defined artificial intelligence (AI) models configured to perform the target virtualized network function (Step 234), and running the one or more the software-defined AI models on the COTS hardware (Step 236). For instance, the target virtualized network function comprises massive MIMO, beamforming, interference mitigation or a combination thereof. The plurality of factors include a low latency, high performance computing, a resource tradeoff, or a combination thereof.

In various embodiments, the method 230 further includes replacing a purpose-built hardware with the one or more the software-defined AI models on the COTS hardware in the network node. In the method 230, the selecting the target virtualized network function further comprises identifying a network function that is performed by the purpose-built hardware, dividing the network function into multiple computing functions, and implementing the multiple computing functions with the one or more the software-defined AI models running on the COTS hardware. The method 230 further comprises facilitating communications between the one or more the software-defined AI models and a plurality of the software-defined AI models distributed in the plurality of network nodes. The plurality of network nodes comprises a user equipment, a radio access network, a mobile core network, or a combination thereof. In some embodiments, the plurality of virtualized network functions comprises RAN functions, and the method 230 further comprise coordinating with multiple software-defined AI models distributed in the plurality of network nodes to complete one or more of the RAN functions via the communications.

FIG. 2F depicts an illustrative embodiment of another method 240 in accordance with various aspects described herein. In various embodiments, the method 240 includes selecting a virtualized network function among a plurality of virtualized network functions in multiple network nodes distributed in a wireless mobility network (Step 242). The plurality of virtualized network functions are not running on a purpose-built hardware. The selecting (Step 242) is based on a plurality of requirements including a low latency, high performance computing, a resource tradeoff, or a combination thereof. The method 240 further includes implementing the selected virtualized network function with a software-defined artificial intelligence (AI) model (Step 244) and running the software-defined AI model on a commercial off-the-shelf (COTS) hardware (Step 246). By way of example, the plurality of virtualized network functions comprise radio access network (RAN) functions, and the RAN functions include massive MIMO, beamforming, interference mitigation or a combination thereof. The method 240 further includes utilizing another the software-defined AI model distributed in a different network node to contribute to perform one or more of the RAN functions.

In various embodiments, the method 240 further includes identifying a network function that is performed on the purpose-built hardware, dividing the network function into multiple software-defined functions, implementing the multiple software-defined functions with one or more the software-defined AI models, and running the one or more software defined AI models on the COTS hardware. The method 240 further includes facilitating communications between the software-defined AI model and a plurality of software-defined AI models distributed in the multiple network nodes, where the multiple network nodes comprise a user equipment, a radio access network, a mobile core network, or a combination thereof.

In various embodiments, the method 240 further includes facilitating coordination with the plurality of software-defined AI models distributed in the multiple network nodes to complete the RAN function via the communications. The RAN function comprises multi-user massive MIMO pairing, and the method 240 further includes determining, using the software-defined AI model, a performance estimation with respect to a first multi-user pair in the multi-user massive MIMO pairing, and coordinating, with the plurality of software-defined AI models, performance estimations with respect to a plurality of multi-user pairs including a second multi-user pair and a third multi-user pair in the multi-user massive MIMO pairing. The method 240 further includes comparing the performance estimations with respect to the first multi-user pair and the plurality of multi-user pairs and selecting multi-user pair having a best performance estimation.

In various embodiments, the method 240 further includes decoupling a network function from a purpose-built hardware, dividing the decoupled network function into multiple software-defined functions, implementing the multiple software-defined functions with one or more the software-defined AI models, and running the one or more software defined AI models on the COTS hardware.

While for purposes of simplicity of explanation, the respective processes are shown and described as a series of blocks in FIGS. 2E-2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In the above-described embodiments, the system is configured to deploy a plurality of software-defined artificial intelligence (AI) models across distributed network nodes in a wireless mobility network. The plurality of the software-defined AI models are configured to perform one or more virtualized network functions in the wireless mobility network. The system is further configured to utilize commercial off-the-shelf (COTS) hardware to run the plurality of the software-defined AI models. By way of example, the one or more virtualized network functions comprise a massive MIMO function, and the system is further configured to evaluate multiple user pair combinations in the massive MIMO function using the plurality of the software-defined AI models in one or more network nodes in the wireless mobility network. The evaluating includes estimating a performance of each user pair based on predefined criteria using the plurality of the software-defined AI models. The system is further configured to determine the one or more virtualized network functions in the wireless mobility network to be implemented with one or more of the plurality of the software-defined AI models without utilizing a purpose-built hardware, wherein the one or more virtualized network functions comprise interference mitigation.

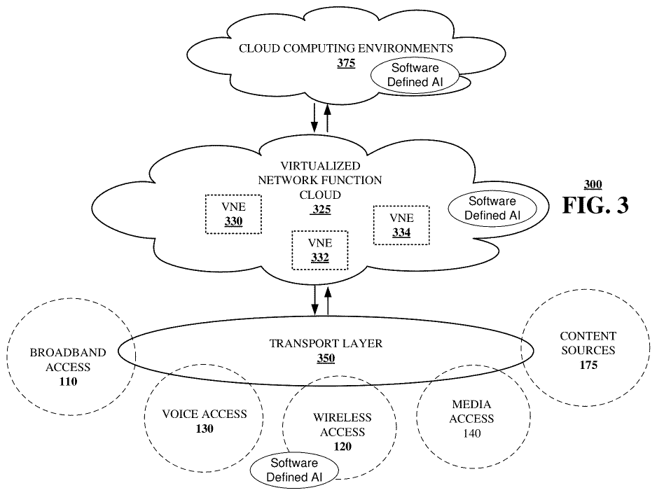

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C, and 3. For example, virtualized communication network 300 can facilitate in whole or in part systems and methods for implementing software-defined artificial intelligence (AI) in wireless mobility networks.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software-defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

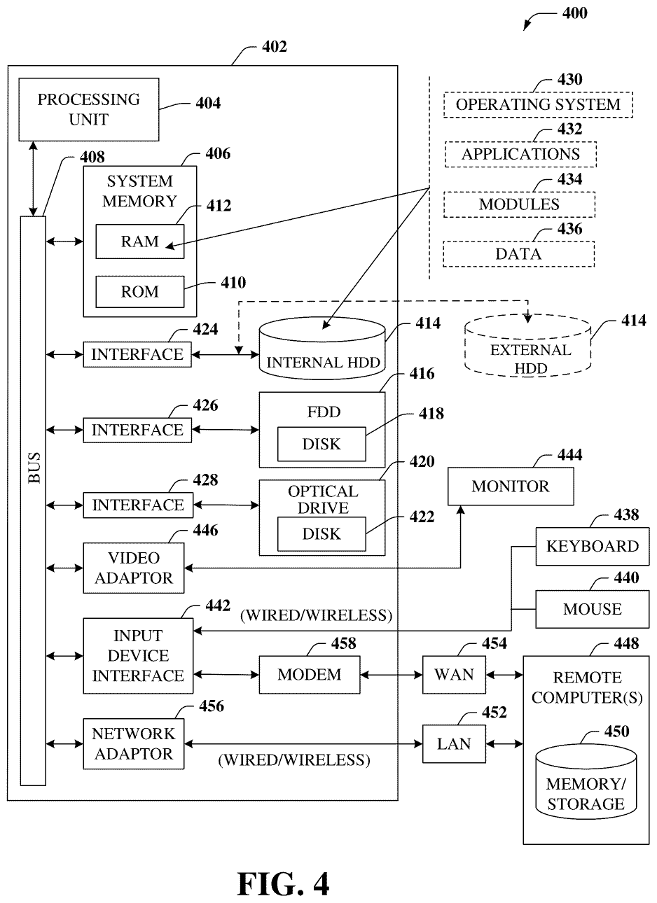

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part systems and methods for implementing software-defined artificial intelligence (AI) in wireless mobility networks.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

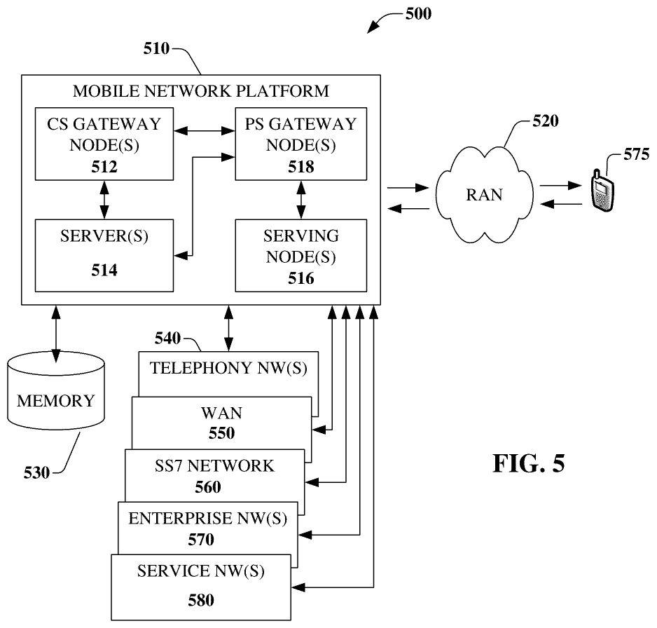

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part systems and methods for implementing software-defined artificial intelligence (AI) in wireless mobility networks. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

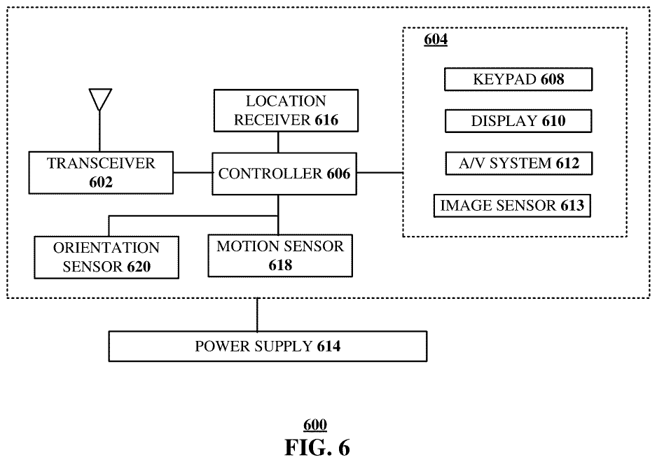

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part systems and methods for implementing software-defined artificial intelligence (AI) in wireless mobility networks.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A system, comprising:
a processing system including a processor of a network node in a wireless mobility network;
a memory that stores executable instructions that, when executed by the processing system, facilitate performance of operations, the operations comprising:
selecting a target virtualized network function among a plurality of virtualized network functions based on a plurality of factors;
deploying one or more software-defined artificial intelligence (AI) models configured to perform the target virtualized network function; and
running the one or more software-defined AI models on a commercial off-the-shelf (COTS) hardware.

2. The system of claim 1, wherein the target virtualized network function comprises massive MIMO, beamforming, interference mitigation or a combination thereof.

3. The system of claim 1, wherein the plurality of factors include a low latency, high performance computing, a resource tradeoff, or a combination thereof.

4. The system of claim 1, wherein the selecting the target virtualized network function further comprises identifying a network function that is performed by a purpose-built hardware, dividing the network function into multiple computing functions, and implementing the multiple computing functions with the one or more software-defined AI models running on the COTS hardware.

5. The system of claim 1, wherein the operations further comprises facilitating communications between the one or more software-defined AI models and a plurality of software-defined AI models distributed in a plurality of network nodes, wherein the plurality of network nodes comprises a user equipment, a radio access network, a mobile core network, or a combination thereof.

6. The system of claim 5, wherein the plurality of virtualized network functions comprises RAN functions, and wherein the operations further comprise coordinating with multiple software-defined AI models distributed in the plurality of network nodes to complete one or more of the RAN functions via the communications.

7. A non-transitory machine-readable medium, comprising executable instructions that, when executed by a processing system including a processor, facilitate performance of operations, the operations comprising:
selecting a virtualized network function among a plurality of virtualized network functions in multiple network nodes distributed in a wireless mobility network, wherein the plurality of virtualized network functions are not running on a purpose-built hardware, and wherein the selecting is based on a plurality of requirements including a low latency, high performance computing, a resource tradeoff, or a combination thereof;
implementing the selected virtualized network function with a software-defined artificial intelligence (AI) model; and
running the software-defined AI model on a commercial off-the-shelf (COTS) hardware.

8. The non-transitory machine-readable medium of claim 7, wherein the plurality of virtualized network functions comprise radio access network (RAN) functions, and the RAN functions include massive MIMO, beamforming, interference mitigation or a combination thereof.

9. The non-transitory machine-readable medium of claim 7, wherein the operations further comprise:
identifying a network function that is performed on a purpose-built hardware;
dividing the network function into multiple software-defined functions;
implementing the multiple software-defined functions with one or more software-defined AI models; and
running the one or more software defined AI models on the COTS hardware.

10. The non-transitory machine-readable medium of claim 7, wherein the operations further comprise facilitating communications between the software-defined AI model and a plurality of software-defined AI models distributed in the multiple network nodes, wherein the multiple network nodes comprise a user equipment, a radio access network, a mobile core network, or a combination thereof.

11. The non-transitory machine-readable medium of claim 10, wherein the virtualized network function comprises a RAN function, and the operations further comprise facilitating coordination with the plurality of software-defined AI models distributed in the multiple network nodes to complete the RAN function via the communications.

12. The non-transitory machine-readable medium of claim 11, wherein the RAN function comprises multi-user massive MIMO pairing, and wherein the operations further comprise:
determining, using the software-defined AI model, a performance estimation with respect to a first multi-user pair in the multi-user massive MIMO pairing; and
coordinating, with the plurality of software-defined AI models, performance estimations with respect to a plurality of multi-user pairs including a second multi-user pair and a third multi-user pair in the multi-user massive MIMO pairing.

13. The non-transitory machine-readable medium of claim 12, wherein the operations further comprises comparing the performance estimations with respect to the first multi-user pair and the plurality of multi-user pairs and selecting multi-user pair having a best performance estimation.

14. The non-transitory machine-readable medium of claim 7, wherein the operations further comprise:
decoupling a network function from a purpose-built hardware;
dividing the decoupled network function into multiple software-defined functions;
implementing the multiple software-defined functions with one or more software-defined AI models; and
running the one or more software defined AI models on the COTS hardware.

15. A method, comprising:
deploying, by a processing system including a processor, a plurality of software-defined artificial intelligence (AI) models across distributed network nodes in a wireless mobility network, wherein the plurality of software-defined AI models are configured to perform one or more virtualized network functions in the wireless mobility network; and
utilizing, by the processing system, commercial off-the-shelf (COTS) hardware to run the plurality of software-defined AI models.

16. The method of claim 15, wherein the one or more virtualized network functions comprise a massive MIMO function, and wherein the method further comprises evaluating, by the processing system, multiple user pair combinations in the massive MIMO function using the plurality of software-defined AI models in one or more network nodes in the wireless mobility network, wherein the evaluating includes estimating a performance of each user pair in the multiple user pair combinations based on predefined criteria using the plurality of software-defined AI models.

17. The method of claim 16, further comprising:
selecting, by the processing system, a user pair with a best performance using the plurality of software-defined AI models.

18. The method of claim 15, further comprising:
selecting, by the processing system, a network function that is performed on a purpose-built hardware;
dividing, by the processing system, the selected network function into a group of multiple functions; and
implementing, by the processing system, the group of multiple functions with the plurality of software-defined AI models.

19. The method of claim 18, comprising:
executing, by the processing system, the plurality of software-defined AI models implementing the group of multiple functions on the COTS hardware.

20. The method of claim 15, further comprising:
selecting, by the processing system, the one or more virtualized network functions performed by the plurality of software-defined AI models based on a plurality of parameters, wherein the plurality of parameters include a low latency, high performance computing, a resource tradeoff, or a combination thereof.
